(19) United States
(12) Patent Application Publication
(10) Pub. No.: US 2025/0371323 A1
(43) Pub. Date: Dec. 4, 2025

(54) EXPLAINABLE TIME SERIES CLASSIFICATION USING SHAPELETS

(71) Applicants: International Business Machines Corporation, Armonk, NY (US); Rensselaer Polytechnic Institute, Troy, NY (US)

(72) Inventors: Yunshi Wen, Troy, NY (US); Ronny Luss, Glen Rock, NJ (US); Tengfei Ma, White Plains, NY (US); Achille Belly Fokoue-Nkoutche, White Plains, NY (US); Debarun Bhattacharjya, New York, NY (US)

(21) Appl. No.: 18/678,902

(22) Filed: May 30, 2024

(51) Int. Cl. G06N 3/0475; G06N 3/048; G06N 3/08

(52) U.S. Cl. CPC G06N 3/0475; G06N 3/048; G06N 3/08

(57) ABSTRACT

Multivariate time series sample data is received. A shapelet concept bottleneck model (SCBM) is used to determine a likelihood that a shapelet occurs by calculating an m^{th} dimension of a time series data point of the multivariate time series sample data and an m^{th} dimension of univariate shapelet with length, where the shapelet concept bottleneck model is a linear layer over the likelihood of the shapelet occurring. The shapelet concept bottleneck model is trained with an additional classification loss with shapelet concept bottleneck model regularizations. The explainable time series classifications are generated based on the trained shapelet concept bottleneck model.

### BACKGROUND

The present invention relates generally to the electrical, electronic and computer arts and, more particularly, to machine learning.

Time-series classification is a pertinent task for time-series (TS) data. Depending on the number of observed variables, TS classification problems can be categorized as either univariate or multivariate TS classification. Despite the difference in complexity, both categories are involved in a wide range of applications. For example, univariate TS classification data includes image outlines, sound, spectrographs, and the like, and multivariate TS classification data includes electroencephalogram (EEG), electrocardiogram (ECG), human activity recognition (HAR), and the like. These types of TS data appear in significant applications such as healthcare, neuroscience, and automation. In recent years, there has been an increasing trend of applying deep learning models to TS classification problems. However, despite achieving state-of-the-art performance, deep models typically lack interpretability.

### BRIEF SUMMARY

Principles of the invention provide techniques for explainable time series classification using shapelets. In one aspect, an exemplary method includes the operations of receiving multivariate time series sample data; using a shapelet concept bottleneck model (SCBM) to determine a likelihood that a shapelet occurs by calculating an m^{th} dimension of a time series data point of the multivariate time series sample data and an m^{th} dimension of univariate shapelet, where the shapelet concept bottleneck model is a linear layer over the likelihood of the shapelet occurring; training the shapelet concept bottleneck model with an additional classification loss with shapelet concept bottleneck model regularizations; and generating the explainable time series classifications based on the trained shapelet concept bottleneck model.

In one aspect, a computer program product includes one or more tangible computer-readable storage media and program instructions stored on at least one of the one or more tangible computer-readable storage media, the program instructions executable by a processor, the program instructions including receiving multivariate time series sample data; using a shapelet concept bottleneck model (SCBM) to determine a likelihood that a shapelet occurs by calculating an m^{th} dimension of a time series data point of the multivariate time series sample data and an m^{th} dimension of univariate shapelet, where the shapelet concept bottleneck model is a linear layer over the likelihood of the shapelet occurring; training the shapelet concept bottleneck model with an additional classification loss with shapelet concept bottleneck model regularizations; and generating the explainable time series classifications based on the trained shapelet concept bottleneck model.

In one aspect, a system includes a memory and at least one processor, coupled to the memory, and operative to perform operations including receiving multivariate time series sample data; using a shapelet concept bottleneck model (SCBM) to determine a likelihood that a shapelet occurs by calculating an m^{th} dimension of a time series data point of the multivariate time series sample data and an m^{th} dimension of univariate shapelet, where the shapelet concept bottleneck model is a linear layer over the likelihood of the shapelet occurring; training the shapelet concept bottleneck model with an additional classification loss with shapelet concept bottleneck model regularizations; and generating the explainable time series classifications based on the trained shapelet concept bottleneck model.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects, as will be discussed further below. Features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 illustrates examples of learned shapelets on six time-series (TS) from a conventional ECG dataset;

FIG. 2 is a high-level block diagram of the SBM, in accordance with an example embodiment;

FIG. 3 is a high-level block diagram of the hybrid-SBM, in accordance with an example embodiment;

FIG. 4 is a visualization of shapelets learned by SBM on a multivariate TS dataset from global explanations, in accordance with an example embodiment;

FIGS. 5A-5C display results of application of an SBM and a hybrid-SBM to a conventional dataset derived using a conventional dimensionality reduction technique, in accordance with example embodiments;

FIG. 6 highlights an example of local explanations on two samples, in accordance with an example embodiment;

FIG. 7 shows a comparison between shapelets learned by (left) radial basis function (RBF) based predicates and (right) threshold-based predicates, in accordance with an example embodiment;

FIGS. 8A and 8B are a table presenting classification accuracy for the conventional time series classification dataset, in accordance with an example embodiment;

FIG. 9 is a table showing the results (for in-hospital mortality predication on the conventional medical information) and illustrating how hybrid-SBM helps SBM on the difficult samples, in accordance with an example embodiment;

FIG. 10 is a table showing results of an ablation study on 10 datasets from the conventional time series classification dataset, in accordance with an example embodiment; and

FIG. 11 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Given the discussion herein (reference characters refer to the drawings discussed below), it will be appreciated that in one aspect, an exemplary method includes receiving multivariate time series sample data; using a shapelet concept bottleneck model (SCBM) to determine a likelihood that a shapelet occurs by calculating an m^{th} dimension of a time series data point of the multivariate time series sample data and an m^{th} dimension of univariate shapelet, where the shapelet concept bottleneck model is a linear layer over the likelihood of the shapelet occurring; training the shapelet concept bottleneck model with an additional classification loss with shapelet concept bottleneck model regularizations; and generating the explainable time series classifications based on the trained shapelet concept bottleneck model. The technical benefits include shapelet concept transforms that improve on shapelets and interpretable models for multivariate time series problems by using probabilities (rather than just distance) and that generate interpretable classifications; a method for building logical predicates from shapelets and an interpretable model for TS classification tasks (referred to as the shapelet bottleneck model (SBM) herein); a novel framework for building the partially interpretable hybrid-SBM model that can improve shapelets because the shapelet learning no longer focuses on samples where the shapelets are not useful, as well as identifying samples where additional expertise is required for prediction; a linear classifier used in conjunction with the shapelet bottleneck representations; and/or a method to build logical predicates from shapelets that offers an interpretable feature space for time-series data.

In one example embodiment, the generating of the explainable time series classifications based on the trained shapelet concept bottleneck model includes generating local explainable time series classifications and global explainable time series classifications based on the trained shapelet concept bottleneck model. The technical benefits include providing local and global explainability for users of the shapelet bottleneck model.

In one example embodiment, a deep neural network (DNN) is used based on the multivariate time series sample data; Gumbel-SoftMax is used to generate an end-to-end differentiable model; and, based on the shapelet concept bottleneck model and the end-to-end differentiable model, a hybrid shapelet concept bottleneck model (H-SCBM) is generated using a gating function to combine the shapelet concept bottleneck model with the deep neural network (DNN); wherein the trained shapelet concept bottleneck model in the generating of the explainable time series classifications operation comprises a trained hybrid shapelet concept bottleneck model; and the training of the shapelet concept bottleneck model with the additional classification loss with the shapelet concept bottleneck model regularizations comprises a training of a hybrid shapelet concept bottleneck model with an additional classification loss for the deep neural network with shapelet concept bottleneck model regularizations. The technical benefits include generating a hybrid model (referred to as hybrid-SBM herein) that integrates shapelet concept transforms with deep learning models by employing a mixture-of-experts approach to eliminate the limitations of only using interpretable shapelet transforms (e.g., a lack of information regarding the number of occurrences of shapelets).

In one example embodiment, the generating of the explainable time series classifications based on the trained hybrid shapelet concept bottleneck model includes generating local explainable time series classifications and global explainable time series classifications based on the trained hybrid shapelet concept bottleneck model. The technical benefits include providing local and global explainability for the trained hybrid shapelet bottleneck model.

In one example embodiment, the generating of the explainable time series classifications based on the trained hybrid shapelet concept bottleneck model includes identifying a relative difficulty of classifying a given sample of the multivariate time series sample data compared to another sample of the multivariate time series sample data. The technical benefits include achieving the advantages as discussed above with a convenient way of doing the generation of the explainable time series classifications.

In one example embodiment, an objective function of the shapelet concept bottleneck model comprises three loss functions:
a classification loss based on a SoftMax cross-entropy loss [symbol] _{ce};
a diversity loss to regulate learning redundant shapelets:

$${ℒ}_{div}^{δ} = \frac{1}{2 KM} {\sum }_{m = 1}^{M} {\sum }_{{k}_{1} = 1}^{K} {\sum }_{\begin{matrix}{k}_{2} = 1 \\ {k}_{2} \neq {k}_{1}\end{matrix}}^{K} {e}^{- ‖ {s}_{{k}_{1}}^{m , δ} - {s}_{{k}_{2}}^{m , δ} ‖ 2} ;$$

a regularization on the classifier weights to encourage sparsity, selecting informative concepts and producing classifiers:

$${ℒ}_{reg}^{δ} = \frac{1}{CKM} {\sum }_{c = 1}^{C} {\sum }_{m = 1}^{M} {\sum }_{k = 1}^{K} \vert {w}_{c , k}^{m , δ} \vert$$

wherein c is a class, C is a count of classes,

$${s}_{k}^{m , δ}$$

represents a shapelet where m is a dimension, M is a count of dimensions, k identifies the shapelet, K is a count of shapelets, w is a weight and δ is an index for a length of a corresponding shapelet. The technical benefits include achieving the advantages as discussed above with an improved way of training the shapelet concept bottleneck model.

In one example embodiment, an overall loss function of the shapelet concept bottleneck model is:

$${ℒ}_{SBM} = {ℒ}_{ce} + \frac{1}{\vert Δ \vert} {\sum }_{δ ∈ Δ} {λ}_{div} {ℒ}_{div}^{δ} + {λ}_{reg} {ℒ}_{reg}^{δ}$$

where λ_{div} and λ_{reg} are hyperparameters, [symbol] _{SBM} is the overall loss function of the shapelet concept bottleneck model. The technical benefits include achieving the advantages as discussed above with an improved way of training the shapelet concept bottleneck model.

In one example embodiment, a global explanation of the explainable time series classifications is defined by:

$${w}_{c , k}^{m , δ} > 0$$

means occurrence of shapelet s is indicative of sample being in class c;

$${w}_{c , k}^{m , δ} = 0$$

means

$${s}_{k}^{m , δ}$$

is unrelated to class c;

$${w}_{c , k}^{m , δ} < 0$$

means occurrence shapelet s is indicative of sample not being in class c,
wherein c is a class, w is a weight in a corresponding linear regression,

$${s}_{k}^{m , δ}$$

represents a shapelet where m is a dimension, k is identifies the shapelet, and δ is an index for a length of a corresponding shapelet. The technical benefits include providing the local and global explainability with additional detail.

In one example embodiment, the gating function is a modified Gini Index that measures a diversity of variables in an output \hat{R}ᵢ of the shapelet concept bottleneck model and is defined as:

$$g ( {X}_{i} ) = \frac{C \cdot {\sum }_{c = 1}^{C} {( {\hat{r}}_{i , c} )}^{2} - 1}{C - 1}$$

wherein c is a class, C is a count of classes, and \hat{r}_{i,c} are components.

The technical benefit is to provide a measure of confidence in whether the SBM should be trusted via equation (7).

In one example embodiment, an output of the hybrid shapelet concept bottleneck model is a mixture of outputs of the shapelet concept bottleneck model, denoted as SBM, and the deep neural network, denoted as DNN, with ratio g(Xᵢ):

$$H ( {X}_{i} ) = SBM ( {X}_{i} ) \cdot g ( {X}_{i} ) + DNN ( {X}_{i} ) \cdot ( 1 - g ( {X}_{i} ) )$$

wherein H(Xᵢ) is an output of the hybrid shapelet concept bottleneck model. The technical benefits include achieving the advantages as discussed above with a convenient way of generating the output of the hybrid shapelet concept bottleneck model.

In one example embodiment, an overall loss function of the hybrid shapelet concept bottleneck model is:

$${ℒ}_{Hybrid} = {ℒ}_{SBM} + {\overline{ℒ}}_{ce} \qquad ( 9 )$$

where [symbol] _{ce} is a SoftMax cross-entropy loss on H(Xᵢ) to optimize an overall performance of the hybrid shapelet concept bottleneck model and [symbol] _{SBM} is an overall loss function of the shapelet concept bottleneck model. The technical benefit is an optimized performance of the hybrid shapelet concept bottleneck model.

In one example embodiment, it is determined that the explainable time series classifications provide a satisfactory explanation; and an action is performed based on the classification in response to determining that the explainable time series classifications provide the satisfactory explanation. The technical benefits include utilizing the explainable time series classifications to perform an action.

In one example embodiment, the action is determining a treatment for a patient based on the explainable time series classifications. The technical benefits include determining a treatment for a patient utilizing the explainable time series classifications.

In one example embodiment, the action is managing a physical system and wherein the multivariate time series sample data is obtained from sensors configured to monitor the physical system. The technical benefits include the management of a physical system utilizing the explainable time series classifications.

In one example embodiment, it is determined that the explainable time series classifications fail to provide a satisfactory explanation; and at least one of a human subject expert or a deep neural network is used in response to determining that the explainable time series classifications fail to provide the satisfactory explanation. The technical benefits include using the most appropriate technique in performing the classification.

In one aspect, a computer program product comprises one or more tangible computer-readable storage media and program instructions stored on at least one of the one or more tangible computer-readable storage media, the program instructions executable by a processor, the program instructions comprising receiving multivariate time series sample data; using a shapelet concept bottleneck model (SCBM) to determine a likelihood that a shapelet occurs by calculating an m^{th} dimension of a time series data point of the multivariate time series sample data and an m^{th} dimension of univariate shapelet, where the shapelet concept bottleneck model is a linear layer over the likelihood of the shapelet occurring; training the shapelet concept bottleneck model with an additional classification loss with shapelet concept bottleneck model regularizations; and generating the explainable time series classifications based on the trained shapelet concept bottleneck model. The technical benefits include shapelet concept transforms that improve on shapelets and interpretable models for multivariate time series problems by using probabilities (rather than just distance) and that generate interpretable classifications; a method for building logical predicates from shapelets and an interpretable model for TS classification tasks (referred to as the shapelet bottleneck model (SBM) herein); a novel framework for building the partially interpretable hybrid-SBM model that can improve shapelets because the shapelet learning no longer focuses on samples where the shapelets are not useful, as well as identifying samples where additional expertise is required for prediction; a linear classifier used in conjunction with the shapelet bottleneck representations; and/or a method to build logical predicates from shapelets that offers an interpretable feature space for time-series data.

In one aspect, a system comprises a memory and at least one processor, coupled to the memory, and operative to perform operations comprising receiving multivariate time series sample data; using a shapelet concept bottleneck model (SCBM) to determine a likelihood that a shapelet occurs by calculating an m^{th} dimension of a time series data point of the multivariate time series sample data and an m^{th} dimension of univariate shapelet, where the shapelet concept bottleneck model is a linear layer over the likelihood of the shapelet occurring; training the shapelet concept bottleneck model with an additional classification loss with shapelet concept bottleneck model regularizations; and generating the explainable time series classifications based on the trained shapelet concept bottleneck model. The technical benefits include shapelet concept transforms that improve on shapelets and interpretable models for multivariate time series problems by using probabilities (rather than just distance) and that generate interpretable classifications; a method for building logical predicates from shapelets and an interpretable model for TS classification tasks (referred to as the shapelet bottleneck model (SBM) herein); a novel framework for building the partially interpretable hybrid-SBM model that can improve shapelets because the shapelet learning no longer focuses on samples where the shapelets are not useful, as well as identifying samples where additional expertise is required for prediction; a linear classifier used in conjunction with the shapelet bottleneck representations; and/or a method to build logical predicates from shapelets that offers an interpretable feature space for time-series data.

In one example embodiment, the sensors detect an anomaly of the physical system, such as wear, temperature and the like, and the physical system is classified as suffering from an anomaly. For example, wheel bearings on a train may be monitored for wear and temperature, and a determination made that the wheel bearings are expected to fail soon.

Techniques as disclosed herein can provide substantial beneficial technical effects. Some embodiments may not have these potential advantages and these potential advantages are not necessarily required of all embodiments. By way of example only and without limitation, one or more embodiments can provide one or more of:
shapelet concept transforms that improve on shapelets and interpretable models for multivariate time series problems by using probabilities (rather than just distance) and that generate interpretable classifications;
a method for building logical predicates from shapelets and an interpretable model for TS classification tasks (referred to as the shapelet bottleneck model (SBM) herein);
a hybrid model (referred to as hybrid-SBM herein) that integrates shapelet concept transforms with deep learning models by employing a mixture-of-experts approach to eliminate the limitations of only using interpretable shapelet transforms (e.g., a lack of information regarding the number of occurrences of shapelets);
a novel framework for building the partially interpretable hybrid-SBM model that can improve shapelets because the shapelet learning no longer focuses on samples where the shapelets are not useful, as well as identifying samples where additional expertise is required for prediction;
a linear classifier used in conjunction with the shapelet bottleneck representations;
local and global explainability for the shapelet bottleneck model; and
a method to build logical predicates from shapelets that offers an interpretable feature space for time-series data.

Time-series shapelets offer expressive representations while preserving interpretability in classification tasks. In one example embodiment, shapelet transforms are considered, and a method to build predicates from shapelets is introduced. These novel features are used to formulate the shapelet bottleneck model (SBM), an end-to-end differentiable model for learning interpretable logical classifiers. Furthermore, recognizing the inherent limitations of the shapelet bottleneck, an exemplary “hybrid-SBM” is constructed, which is a hybrid model that integrates SBM and a deep neural network by employing a mixture-of-experts approach. Exemplary models achieve comparable performance with state-of-the-art methods while additionally providing interpretable classifiers for various benchmark datasets. In addition, we have found that the capability of SBM and hybrid-SBM provides interpretability in a real-world application using a conventional medical information dataset.

As noted above, there has been an increasing trend of applying deep learning models to TS classification problems. However, despite achieving state-of-the-art performance, deep models typically lack interpretability. As an example, consider the problem of classifying ECG data using machine learning. While models might be accurate, doctors may hesitate to rely on them without understanding why a patient's heartbeat was classified as being indicative of reduced blood flow to the heart (known as myocardial ischemia).

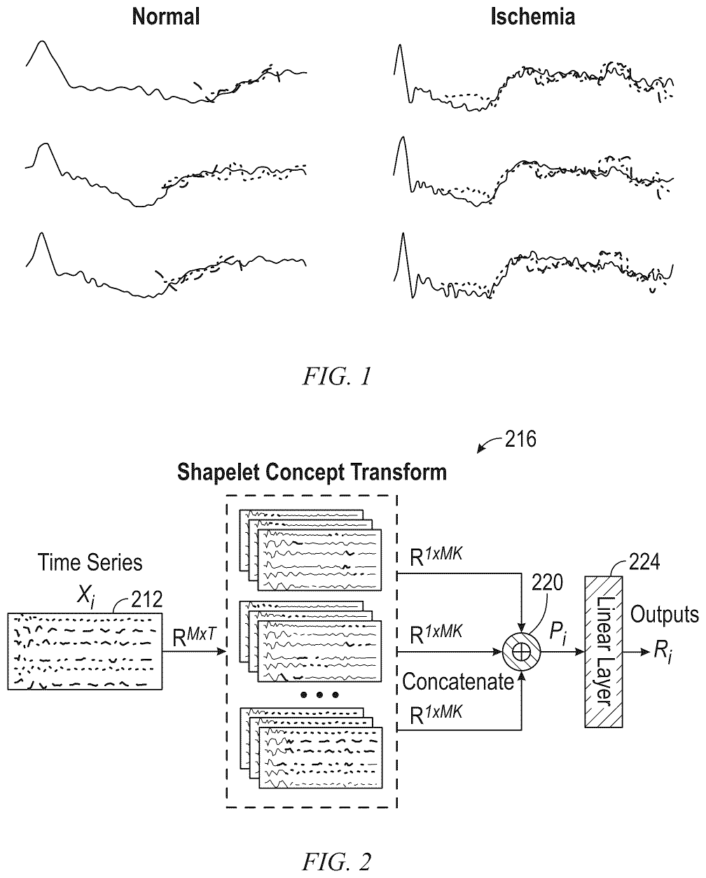

FIG. 1 illustrates examples of learned shapelets on six time-series (TS) from a conventional ECG dataset. Two essential shapelets from local explanations are visualized with different dashed lines. An exemplary model seeks to provide such trust by discovering classifiers based on understandable concepts, such as those illustrated in FIG. 1, where heartbeats are classified according to the existence of patterns known as shapelets. Each sample is plotted with two significant shapelets, shown with short dashed and long dashed lines, which contribute to the prediction. Note that all shapelets signifying ischemia contain downward trends, while no such shapelets were used to classify normal heartbeats. A doctor may take comfort in seeing such patterns that were deemed important to the predictions.

Interpretability can be significant in two perspectives. Firstly, in applications such as healthcare and physical systems, where safety is essential, interpreting a model allows a validation of reliability, trustworthiness, and fairness. Secondly, in challenging tasks, knowledge about the problem can be gained by interpreting patterns found by machine learning models during training, providing insights to understanding TS data. Existing interpretable time-series methods include post-hoc explainability which explain the behavior of a trained deep learning model, often using a surrogate model, and self-explainable models for which model predictions are directly interpretable. One focus below is on self-explainable models.

Towards self-explainability, machine learning models can be combined with logical expressions to gain interpretability. For example, one conventional technique combines a neuro-symbolic model with signal temporal logic, defining soft-logic predicates on each time stamp, and having logic rules to describe the classes. Although such approaches are defined to be interpretable, understanding the logic rules when applied to complex tasks can result in numerous predicates and operators. In example embodiments, shapelets are incorporated to build more expressive, yet interpretable, predicates, which reduce the number of parameters in the logic-based classifier.

Shapelets are recognized as expressive features for TS data. An exemplary method builds logical predicates from shapelets and an interpretable model for TS classification tasks that is termed the shapelet bottleneck model (SBM). Compared to previous methods, exemplary models have simpler structures and training procedures while achieving the same or better performance.

In the time-series setting, one or more exemplary embodiments view shapelets as concepts, building predicates on concepts. SBMs are end-to-end differentiable models that can learn interpretable classifiers for both univariate and multivariate classification tasks. SBMs add a linear classifier to the shapelet representations. Since the concept probabilities are logical predicates, the linear combinations of concepts are interpretable logics, with the weights representing the importance of the corresponding concept to the classes.

In shapelet-based models, including exemplary embodiments of SBM, the learned representations from shapelets may not be able to capture other essential features for some categories of data, such as data with significant features in the frequency domain; SBM is thus combined with a deep neural network by a suitable gating (e.g., a novel gating such as mixture-of-experts (MoE) gating) and the hybrid shapelet bottleneck model (Hybrid-SBM) is introduced. We have found that SBM achieves comparable performance with state-of-the-art methods and that exemplary embodiments of hybrid-SBM outperform them on a conventional time series classification dataset. The interpretablity of one or more exemplary models is illustrated on multivariate TS classification datasets. Finally, SBM and hybrid-SBM are applied on a real-world dataset to demonstrate the effectiveness and interpretablity in practical applications. Note that the terms “interpretable” and “explainable” are used interchangeably herein. One or more embodiments thus advantageously provide:
1. a novel method to build logical predicates from shapelets that offers an interpretable feature space for time-series data;
2. a self-explainable time-series classification model termed SBM, offering both local and global explainability; and/or
3. a novel framework for building partially interpretable hybrid models, hybrid-SBM, that can improve shapelets because shapelet learning no longer focuses on samples where the shapelets are not useful, as well as identifying samples where additional expertise is required for prediction.

Most existing shapelet-based methods predict class labels with a classifier on the shapelet transform features that transform time series into a new space based on distances to selected shapelets. However, the distance-based representation does not necessarily reflect the existence of a shapelet, producing shapelets that deviate from the original TS, which need to be explicitly optimized using techniques such as adversarial training. One or more exemplary embodiments instead derive the logic predicates to reflect the probabilities of shapelets in time series and explain the classification results based on these probabilities and their linear combinations, producing more understandable features (as compared to the prior art) without additional components.

### 3 Shapelet Bottleneck Model

For a set of TS data [symbol] ={X₁, . . . , X_{N}}, where N is the number of samples, Xᵢ∈ [symbol] ^{M×T} denotes a sample where M is the number of variables and T is the time length. In classification problems, [symbol] ={Y₁, . . . , Y_{N}} denotes the labels of [symbol] with Yᵢ∈{1, . . . , C}. Note that the shapelet length has an essential effect on model performance. In conventional time series shapelet techniques, the length is a hyperparameter to tune. Additional flexibility is introduced by including shapelets with various lengths by taking shapelets of length L_{δ}=max(┌δT┐, 2), ∀δ∈Δ={0.05, 0.1, 0.2, 0.3, 0.5, 0.8}. The set of shapelets S={S^{1,δ}, . . . , S^{M,δ}: δ∈Δ} contains M|Δ| subsets of univariate shapelets with each set S^{m,δ} defined on the m^{th} data variable as

$${S}^{M , δ} = \{ {s}_{1}^{m , δ} , … , {s}_{K}^{m , δ} \}$$

for all δ∈Δ where K is the number of shapelets in each subset. (A shapelet can be, for example, 1 minute, 5 minutes, or 10 minutes long, where delta can take values of 1, 2 or 3 corresponding to the 1, 5, and 10 minutes lengths. Summing over delta, as in equation (3), is equivalent to a summing over the different possible lengths that shapelets can take.) Univariate shapelets

$${s}_{k}^{m , δ} ∈ {ℝ}^{1 \times {L}_{δ}}$$

in S^{m,δ} have length L_{δ}. Therefore, the SBM has a total of MK|Δ| univariate shapelets.
3.1 Building Predicates from Shapelets

Denote

$${x}_{i}^{m} ∈ {ℝ}^{1 \times T}$$

as the m^{th} dimension of Xᵢ and

$${x}_{i , t : t + {L}_{δ}}^{m}$$

as the subsequence of

$${x}_{i}^{m}$$

between timestamp t and t+L_{δ}. The distance between

$${S}_{k}^{m , δ}$$

and a subsequence of

$${x}_{i}^{m}$$

is defined as:

$$d ( {x}_{i , t : t + {L}_{δ}}^{m} , {s}_{k}^{m , δ} ) = \frac{1}{{L}_{δ}} {\sum }_{l = 1}^{{L}_{δ}} {( {x}_{i , t : t + l - 1}^{m} - {s}_{k , l}^{m , δ} )}^{2} \qquad ( 1 )$$

where

$${s}_{k , l}^{m , δ}$$

is the l^{th} point of

$${s}_{k}^{m , δ} .$$

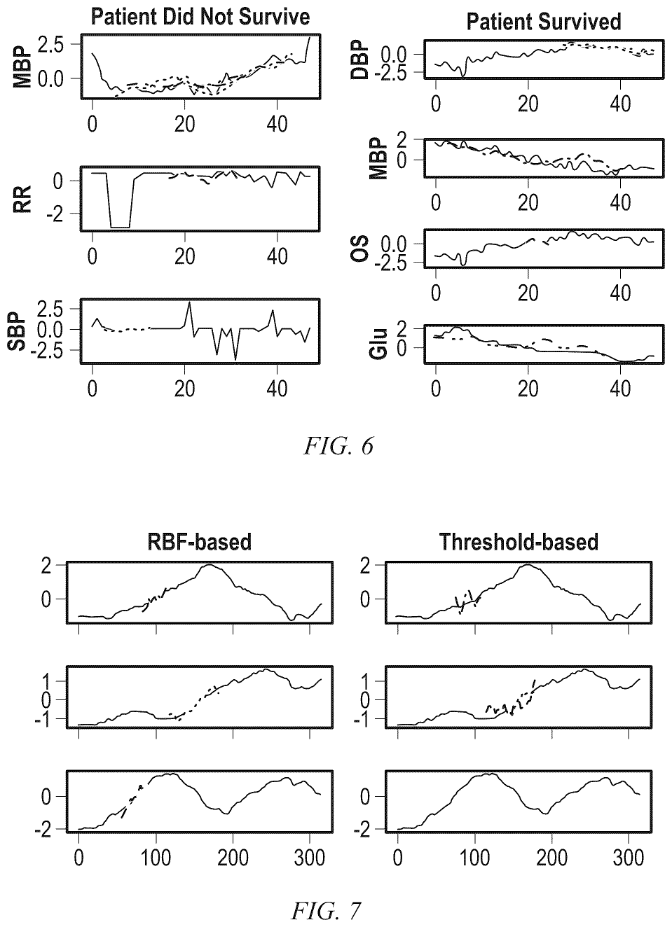

A straightforward way to express predictions with logical classifiers is to use predicates. One conventional technique constructs a logical predicate with a threshold distance; however, when combined with the conventional time series shapelets technique, this approach is found to reduce shapelet quality (essential shapelets are not similar to the TS) as well as interpretability (notion of distance can vary across datasets), since the threshold distance does not directly reflect the existence of a shapelet (see FIG. 7 for an example). Therefore, shapelets are viewed as interpretable concepts for TS and build logical predicates directly from shapelet distances. Formally:

$${p}_{k , l}^{m , δ} = {max}_{t = 1 … , T - L + 1} {e}^{- {( ϵ \cdot d ( {x}_{i , t : t + {L}_{δ}}^{m} , {s}_{k}^{m , δ} ) )}^{2}} \qquad ( 2 )$$

using a Gaussian radial basis function on the distance to measure the probability that

$${s}_{k}^{m , δ}$$

exists in

$${x}_{i}^{m} ,$$

where ϵ is a scaling parameter to tune. The set of shapelets S transforms each sample Xᵢ∈χ to probabilities Pᵢ∈ [symbol] ^{1×MK|Δ|}, where

$${P}_{i}^{δ} ∈ {ℝ}^{1 \times MK}$$

in Pᵢ is a vector containing concept probabilities for sample i for all M variables and K shapelets with length L_{δ}.

### 3.2 End-to-End Differentiable Model

The traditional min and max operators are not differentiable. The conventional time series shapelets technique employs a softened minimize operator with very high temperature. However, the approximation is not accurate and the gradients are diminishing. In some cases, the conventional time series shapelets technique can be improved upon, for example, by using the Gumbel-SoftMax trick that makes max in Equation (2) have the same gradient as SoftMax while maintaining the exact value. The concept probabilities Pᵢ are fed into a linear layer to compute the outputs:

$${r}_{i , c} = {\sum }_{δ ∈ Δ} {\sum }_{m = 1}^{M} {\sum }_{k = 1}^{K} {w}_{c , k}^{m , δ} {p}_{i , k}^{m , δ} , ∀ c ∈ \{ 1 , … , C \} \qquad ( 3 )$$

where

$${p}_{i , k}^{m , δ}$$

is the concept probability of shapelet

$${s}_{k}^{m , δ} .$$

The SBM's output is Rᵢ∈ [symbol] ^{c}={r_{i,1}, . . . , r_{i,c}}. FIG. 2 is a high-level block diagram of the SBM, in accordance with an example embodiment. As illustrated in FIG. 2, multi-variate time series data 212 is input into the SBM. Each component m of the M components of the multi-variate time series data is of length T. Shapelet concept transforms 216 apply equations (1) and (2) to each of the input time series data. (Shapelet concept transforms 216 are applied to each component individually via equations (1) and (2) (that is, via index m in equations (1) and (2)). The SCTs for each component and each time step delta are then combined via equation (3), as described below.) The outputs, such as probabilities, generated based on equation (2) are concatenated by concatenator 220. A linear layer 224 performs a linear regression on the probabilities provided by the concatenator 220. Note that the different shapelet lengths are illustrated vertically under Shapelet Bottleneck; each row allows shapelets of length L_{δ} across all variables.

### 3.3 Training

SBM is end-to-end differentiable and trained using gradient-based optimization. The objective function contains the following three loss functions:
classification loss: SoftMax cross-entropy loss [symbol] _{ce},
a diversity loss to regulate learning redundant shapelets:

$${ℒ}_{div}^{δ} = \frac{1}{2 KM} {\sum }_{m = 1}^{M} {\sum }_{{k}_{1} = 1}^{K} {\sum }_{{{k}_{2} = 1}_{{k}_{2} \neq {k}_{1}}}^{K} {e}^{- ‖ {s}_{{k}_{1}}^{m , δ} - {s}_{{k}_{2}}^{m , δ} ‖ 2} \qquad ( 4 )$$

regularization on the classifier weights to encourage sparsity, selecting the most informative concepts and producing simple classifiers:

$${ℒ}_{reg}^{δ} = \frac{1}{CKM} {\sum }_{c = 1}^{C} {\sum }_{m = 1}^{M} {\sum }_{k = 1}^{K} \vert {w}_{c , k}^{m , δ} \vert \qquad ( 5 )$$

The overall loss function is

$${ℒ}_{SBM} = {ℒ}_{ce} + \frac{1}{\vert Δ \vert} {\sum }_{δ ∈ Δ} {λ}_{div} {ℒ}_{reg}^{δ} + {λ}_{reg} {ℒ}_{reg}^{δ} \qquad ( 6 )$$

where λ_{div} and λ_{reg} are hyperparameters.

### 3.4 Interpretations

A concept probability

$${p}_{i , k}^{m , δ}$$

is a logical predicate whose value measures the existence of shapelet

$${s}_{k}^{m , δ} .$$

The linear classifier behaves like weighted linear logic, where weights

$${w}_{c , k}^{m , δ}$$

specify the importance of shapelet

$${s}_{k}^{m , δ}$$

to class c. Two exemplary ways to interpret the mode are now discussed.

### Local Explainability

Local explanations answer why the classification decision for a sample Xᵢ was made. In SBM, the explanation has the form of “sample Xᵢ belongs to class c because Xᵢ contains shapelet

$${{s}_{k}^{m , δ}}^{”} ,$$

whose corresponding

$${w}_{c , k}^{m , δ} {p}_{i , k}^{m , δ}$$

is significant. Consider FIG. 1 where the two shapelets are visualized with the largest

$${w}_{c , k}^{m , δ} {p}_{i , k}^{m , δ}$$

for each class. Such interpretations allow the visual validation of the correctness of learned shapelets and classifiers.

### Global Explainability

Global explanations provide knowledge about the classification problem, expressed in SBM by inductive logics without pertaining to particular samples. SBM offers the following global explanation:

$${w}_{c , k}^{m , δ} > 0 :$$

samples in class c should contain

$${s}_{k}^{m , δ} ;$$

$${w}_{c , k}^{m , δ} = 0 \text{:} {s}_{k}^{m , δ}$$

is unrelated to class c;

$${w}_{c , k}^{m , δ} < 0 :$$

samples in class c should not contain

$${s}_{k}^{m , δ} .$$

FIGS. 1, 4 and 7 visualize shapelets with the highest weights in the linear classifier, validating the correctness of the global explanation. For some challenging tasks, local explanations are used to provide visually better explanations for specific samples. Note the difference between local and global explainability: local explanations discuss what does occur in a sample whereas global explanations discuss what should occur in a sample.

### 4 Hybrid Model by Mixture-of-Experts

In the section above entitled “Global Explainability”, the process of building predicates from shapelets was formulated, and SBM, which jointly learns shapelets and logical classifier, was detailed. While the max operator in Equation (2) makes concepts more interpretable, it also reduces expressiveness. For example, the predicates can only measure the existence of shapelets, but lose information about the number of occurrences and corresponding timestamps. In time series with discriminative features in other domains, such as the frequency domain (instead of the time domain), the shapelet bottleneck may not capture essential features for classification. To address this limitation, in one or more embodiments, SBM is combined with a deep neural network (DNN) to make a partially-interpretable hybrid model termed the hybrid-SBM.

### 4.1 Mixture-of-Experts

One or more embodiments combine the output of multiple experts using a novel gating design. For example, a mixture-of-experts (MoE) approach combines the output of multiple expert models with a gating network. Experts have different structures to capture different aspects of the data and the gating network assigns the work to the experts. Additionally, the SBM itself can serve as both the interpretable expert and the gating network, which reduce the number of parameters and improves interpretablity.

The output of Rᵢ=SBM(Xᵢ) minimizes [symbol] _{ce} during training. Denote \hat{R}ᵢ=softmax(Rᵢ) with components \hat{r}_{i,c} responding to Equation (3). (r_{i,c} is a measure that indicates the likelihood that sample i is in class c.) Then, the optimal \hat{R}ᵢ is a one-hot vector with \hat{r}_{i,c}=1 if Yᵢ=c. Diversity of \hat{r}_{i,c} thus measures confidence of the model. When combining an interpretable model and a DNN with MoE, the use of DNN should be inversely proportional to the confidence level of the interpretable model to maximize interpretability. Therefore, the gating function is designed as:

$$g ( {X}_{i} ) = \frac{C \cdot {\sum }_{c = 1}^{C} {( {\hat{r}}_{i , c} )}^{2} - 1}{C - 1} \qquad ( 7 )$$

which is a modified Gini Index that measures the diversity of variables in \hat{R}ᵢ. Intuitively, g(Xᵢ)=0 when values in \hat{R}ᵢ are identical, and g(Xᵢ)=1 when \hat{R}ᵢ is a one-hot vector. The output of the hybrid model is then a mixture of the outputs of SBM and DNN with ratio g(Xᵢ):

$$H ( {X}_{i} ) = SBM ( {X}_{i} ) \cdot g ( {X}_{i} ) + DNN ( {X}_{i} ) \cdot ( 1 - g ( {X}_{i} ) ) \qquad ( 8 )$$

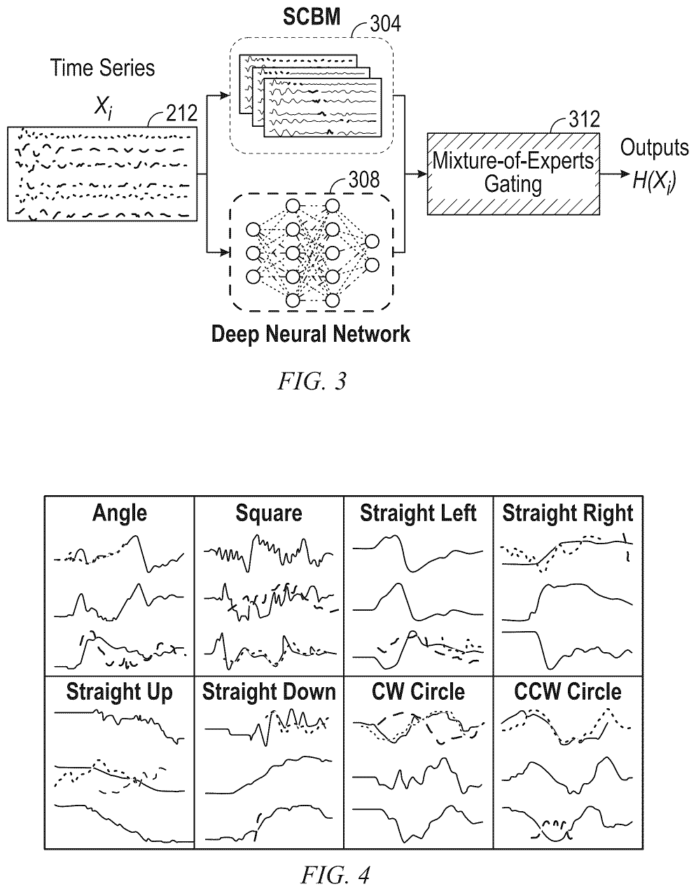

FIG. 3 is a high-level block diagram of the hybrid-SBM, in accordance with an example embodiment. The hybrid SBM includes SBM 304, which represents the system of FIG. 2, and DNN 308, which is a conventional deep neural network (DNN). Both SBM 304 and DNN 308 operate on multi-variate time series data 212. A gating unit 312 (e.g., a mixture of experts gating unit) mixes the outputs of SBM 304 and DNN 308 based on equations (7) and (8).

### 4.2 Training

The overall loss function of the hybrid model is:

$${ℒ}_{Hybrid} = {ℒ}_{SBM} + {\overline{ℒ}}_{ce} \qquad ( 9 )$$

where [symbol] _{ce} is another softmax cross-entropy loss on H(Xᵢ) to optimize the overall performance of the hybrid model. At initialization, weights are random, and the output of SBM is close to a uniform vector, meaning g(Xᵢ)=0 for all samples and the SBM is not trained. As the DNN is trained and performance improves, the internal cross-entropy term trains the SBM. The hybrid model is still end-to-end differentiable and trained using gradient-based optimizations methods.

### 5 Experiments

SBM and Hybrid-SBM are first compared against various methods on the conventional time series classification dataset, presenting insights gained from visualizing concept representations. The benefits of one or more exemplary models are then demonstrated on the real-world application of in-hospital mortality early prediction using the conventional medical information dataset. Ablation studies on the effects of each component in the disclosed models are then described. As a basic hybrid-SBM design, the SBM is combined with a fully convolutional network (FCN) since it has the best performance among the three basic deep models for TS classification.

### 5.1 Multivariate Time Series Classification

First, the performance of SBM and hybrid-SBM are evaluated on 30 datasets from the conventional time series classification dataset and compared with baseline methods including (1) traditional search-based method: Model 1, (2) basic machine learning method: Model 2, (3) recent pattern-based methods: Model 4 and Model 5, and (4) recent deep learning methods: Model 3, Model 6, and Model 7. Model 1 and Model 2 are implemented to obtain their performance and the results for other methods are collected from respective papers.

### Results

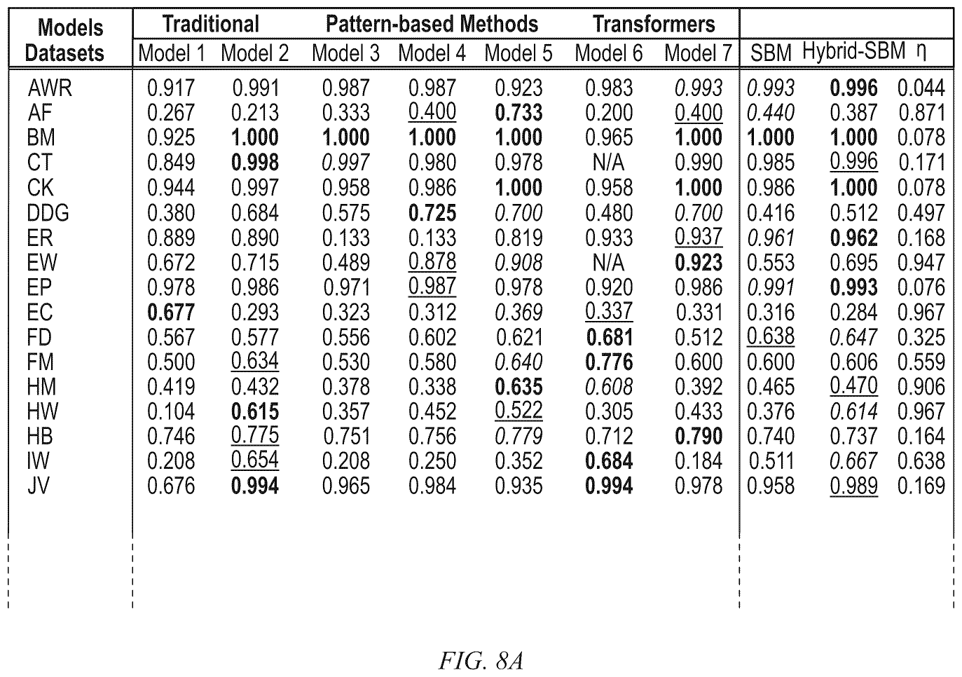

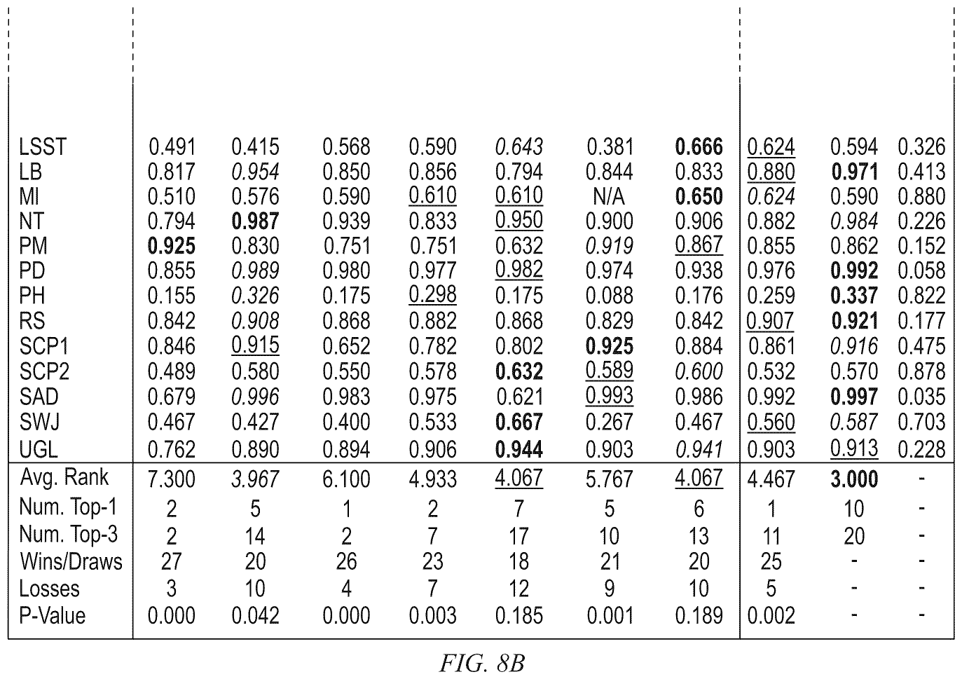

FIGS. 8A and 8B is a table presenting classification accuracy for the conventional time series classification dataset, in accordance with an example embodiment. η in the table measures the average usage of FCN on the test dataset, with:

$$η = \frac{1}{\vert {x}_{test} \vert} {\sum }_{{x}_{i} ∈ {x}_{test}} 1 - g ( {X}_{i} ) \qquad ( 10 )$$

Based on the average rank across the 30 datasets, hybrid-SBM outperforms the baseline methods and SBM achieves comparable performance. (The best accuracy for each dataset is marked with bold, the second-best is marked with italic, and the third-best is marked with underline.)

### Interpretability

In addition to its effective performance, SBM provides interpretable logical classifiers. FIG. 4 is a visualization of shapelets learned by SBM on a multivariate TS dataset from global explanations, in accordance with an example embodiment. (Visualization of an example dataset from the conventional time series classification dataset with accelerometer readings of eight gestures. For example, the classifier can be interpreted as: a “CW Circle” gesture, should contain the long-dashed shapelet but not the short-dashed shapelet in channel 1. In FIG. 4, the long-dashed shapelets have the highest positive weights and the short-dashed shapelets have the lowest negative weights.) FIG. 4 visually confirms that the models capture discriminative shapelet features.

### Shapelet Bottleneck Representation

The effectiveness of the shapelet predicates is explored by viewing probabilities

$${p}_{i , k}^{m , δ}$$

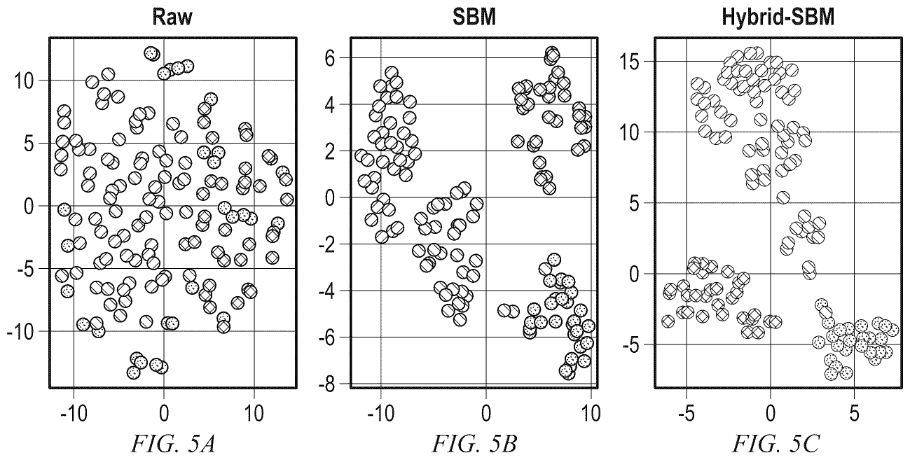

as representations for TS data. FIGS. 5A-5C display results of application of an SBM and a hybrid-SBM to a conventional dataset derived using the dimensionality reduction technique, in accordance with example embodiments. More specifically, FIGS. 5A-5C illustrate dimensionality reduction of (a) raw data Xᵢ, (b) Pᵢ of SBM, and (c) Pᵢ of hybrid-SBM on the conventional dataset. Representations learned by SBM and hybrid-SBM are clearly more separable than the raw TS data. While a few samples are mixed into incorrect clusters (e.g., in the mixture illustrated in the lower, right-hand corner of the results for both the SBM and hybrid-SBM methods), the DNN in the hybrid-SBM model can make corrections and result in better accuracy than SBM. Transparency of data points in plot (c) (right-most plot) represents DNN usage 1−g(Xᵢ). Intuitively, predictions of transparent points are interpretable as they are based on SBM while points having a solid perimeter rely more on the FCN. It was observed that most solid perimeter points lie along the cluster boundaries, meaning hybrid-SBM learns to use an interpretable logical classifier for easier-to-classify samples while relying on the FCN to classify the difficult boundary samples (which can be identified as requiring additional expertise).
5.2 Predicting in-Hospital Mortality

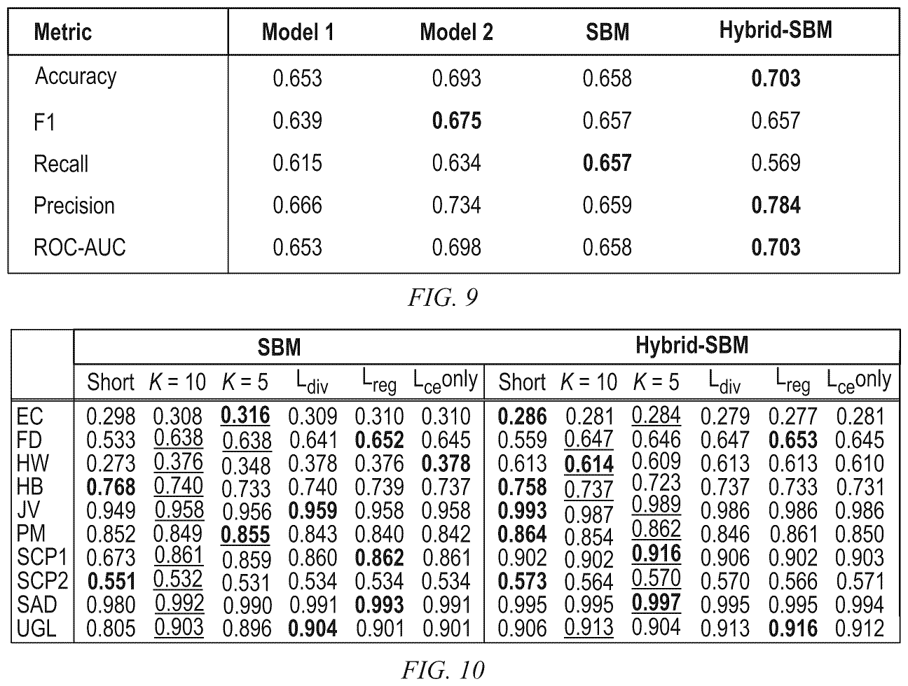

The conventional medical information dataset contains electronic healthcare records from intensive care unit (ICU) patients. (Note, deidentified data was employed for the examples herein). A conventional data procedure is followed to preprocess and generate the data to predict in-hospital mortality based on patient records from the first 48 hours after entering an ICU. A subset of 1500 positive and 1500 negative samples are randomly selected to evaluate the disclosed models. A sample in the dataset is a TS with M=9 and T=48. The subset is divided into 80% training and 20% validation to evaluate the performance using 5-fold cross validation. FIG. 9 is a table showing the results (for in-hospital mortality predication on the conventional medical information) and illustrating how hybrid-SBM helps SBM on the difficult samples, in accordance with an example embodiment.

### Interpretability

FIG. 6 highlights an example of local explanations on two samples, in accordance with an example embodiment. (Local explanations of SBM for in-hospital mortality predication. The variables in the figure are: Mean Blood Pressure (MBP), Respiratory Rate (RR), Systolic Blood Pressure (SBP), Diastolic Blood Pressure (DBP), Oxygen Saturation (OS), and Glucose (Glu).) For better representation, the five most essential shapelets are visualized on their corresponding channels and other channels are omitted. The shapelets and classifier can be interpreted as: the first patient passed away due to increasing MBP, whereas the second survived because of decreasing MBP and Glu. As for global explanations representing general knowledge about whether or not the patient will survive, the learned shapelets and rules are interpreted as: (1) stable heart rate (HR), RR, or temperature, stable or decreasing MBP indicating a patient should survive, (2) increasing HR, SBP or MBP, decreasing temperature or DBP indicating a patient may pass away.

### 5.3 Ablation Study

Ablation studies are performed on a subset of the conventional time series classification dataset containing 10 datasets. The following cases are considered:
short shapelets only, by restricting Δ={0.05, 0.1, 0.2};
different numbers of shapelets using K=5, 10;
[symbol] _{div} where the diversity term in Equation (6) is removed;
[symbol] _{reg} where the sparsity term in Equation (6) is removed; and
[symbol] _{ce} only where both diversity and sparsity terms in Equation (6) are removed.

FIG. 10 is a table showing results of an ablation study on 10 datasets from the conventional time series classification dataset, in accordance with an example embodiment. (The best case for each model is marked with bold. The baseline results reported in the table of FIGS. 8A and 8B are marked with underline.) It is concluded from the table of FIG. 10 that: (1) having shapelets with diverse lengths is desirable, since different datasets may have discriminative features with various scales; 2) for SBM, since adding the diversity and sparsity terms to Equation (6) may improve interpretability by selecting the most informative features, improvements in accuracy were observed when removing them. However, such degradation could be mitigated by tuning λ_{div} and λ_{reg}; (3) for hybrid-SBM, K=5 outperforms other cases since the SBM only focuses on samples where shapelet features are useful and the challenging samples are addressed by the DNN. Additionally, FIG. 7 shows a comparison between shapelets learned by (left) radial basis function (RBF) based predicates and (right) threshold based predicates, in accordance with an example embodiment. The most important three shapelets are visualized. FIG. 7 shows that the disclosed RBF-based predicate design can learn better shapelets than a threshold-based design, as gauged by the fit to the data. Note that there are cases in the table of FIG. 10 that are better than the baseline, but they were omitted in the table of FIGS. 8A and 8B since they do not consistently yield improvement across multiple datasets and do not fully represent the intended design of the disclosed approach.

It is worth noting that generally, confidence from an explanation provided in accordance with aspects of the invention could spur someone to take action based on the factors. On the other hand, if an explanation is not good, rather than re-do the classification, the DNN could be used for classification or a referral to a human subject matter expert can be made. In a non-limiting example, referring to FIG. 6, if a patient is predicted to not survive, those factors could be used as things that should be treated to alter the predicted outcome of the patient.

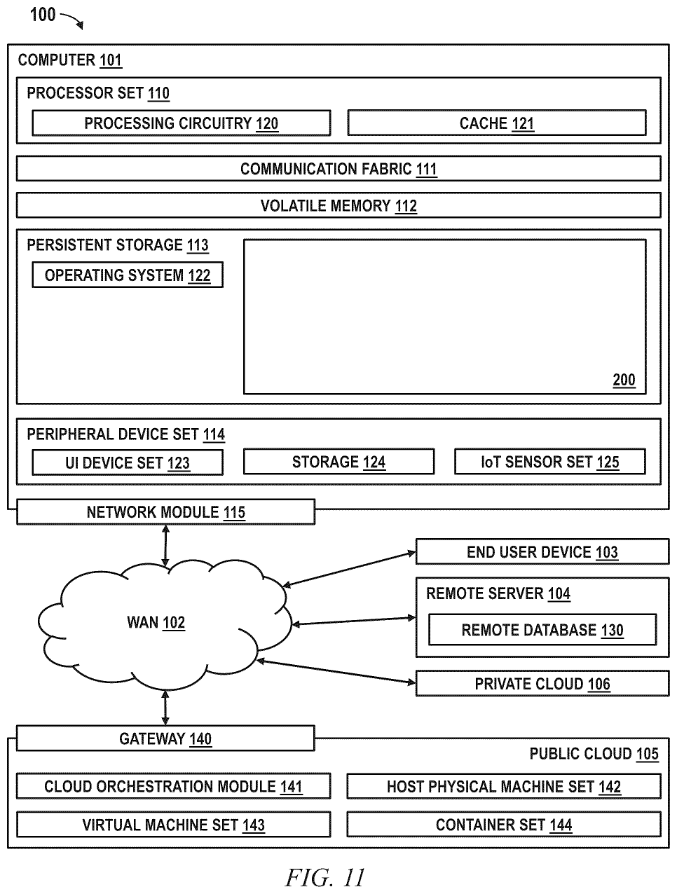

Refer now to FIG. 11.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as machine learning system 200 using shapelets in accordance with aspects of the invention. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 11. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for generating explainable time series classifications, the method comprising;
receiving multivariate time series sample data;
using a shapelet concept bottleneck model (SCBM) to determine a likelihood that a shapelet occurs by calculating an m^{th} dimension of a time series data point of the multivariate time series sample data and an m^{th} dimension of univariate shapelet, where the shapelet concept bottleneck model is a linear layer over the likelihood of the shapelet occurring;
training the shapelet concept bottleneck model with an additional classification loss with shapelet concept bottleneck model regularizations; and
generating the explainable time series classifications based on the trained shapelet concept bottleneck model.

2. The computer-implemented method of claim 1, wherein the generating of the explainable time series classifications based on the trained shapelet concept bottleneck model includes generating local explainable time series classifications and global explainable time series classifications based on the trained shapelet concept bottleneck model.

3. The computer-implemented method of claim 1, further comprising:
using a deep neural network (DNN) based on the multivariate time series sample data;
using Gumbel-SoftMax to generate an end-to-end differentiable model; and
based on the shapelet concept bottleneck model and the end-to-end differentiable model, generating a hybrid shapelet concept bottleneck model (H-SCBM) using a gating function to combine the shapelet concept bottleneck model with the deep neural network (DNN);
wherein:
the trained shapelet concept bottleneck model in the generating of the explainable time series classifications operation comprises a trained hybrid shapelet concept bottleneck model; and
the training of the shapelet concept bottleneck model with the additional classification loss with the shapelet concept bottleneck model regularizations comprises a training of a hybrid shapelet concept bottleneck model with an additional classification loss for the deep neural network with shapelet concept bottleneck model regularizations.

4. The computer-implemented method of claim 3, wherein the generating of the explainable time series classifications based on the trained hybrid shapelet concept bottleneck model includes generating local explainable time series classifications and global explainable time series classifications based on the trained hybrid shapelet concept bottleneck model.

5. The computer-implemented method of claim 3, wherein the generating of the explainable time series classifications based on the trained hybrid shapelet concept bottleneck model includes identifying a relative difficulty of classifying a given sample of the multivariate time series sample data compared to another sample of the multivariate time series sample data.

6. The computer-implemented method of claim 3, wherein an objective function of the shapelet concept bottleneck model comprises three loss functions:
a classification loss based on a SoftMax cross-entropy loss [symbol] _{ce};
a diversity loss to regulate learning redundant shapelets:
$${ℒ}_{div}^{δ} = \frac{1}{2 KM} {\sum }_{m = 1}^{M} {\sum }_{{k}_{1} = 1}^{K} {\sum }_{{{k}_{2} = 1}_{{k}_{2} \neq {k}_{1}}}^{K} {e}^{- ‖ {s}_{{k}_{1}}^{m , δ} - {s}_{{k}_{2}}^{m , δ} ‖ 2} ;$$
and
a regularization on the classifier weights to encourage sparsity, selecting informative concepts and producing classifiers:
$${ℒ}_{reg}^{δ} = \frac{1}{CKM} {\sum }_{c = 1}^{C} {\sum }_{m = 1}^{M} {\sum }_{k = 1}^{K} \vert {w}_{c , k}^{m , δ} \vert$$
wherein c is a class, C is a count of classes,
$${s}_{k}^{m , δ}$$
represents a shapelet where m is a dimension, M is a count of dimensions, k identifies the shapelet, K is a count of shapelets, w is a weight and δ is an index for a length of a corresponding shapelet.

7. The computer-implemented method of claim 6, wherein an overall loss function of the shapelet concept bottleneck model is:
$${ℒ}_{SBM} = {ℒ}_{ce} + \frac{1}{\vert Δ \vert} {\sum }_{δ ∈ Δ} {λ}_{div} {ℒ}_{div}^{δ} + {λ}_{reg} {ℒ}_{reg}^{δ}$$
where λ_{div} and λ_{reg} are hyperparameters, [symbol] _{SBM} is the overall loss function of the shapelet concept bottleneck model.

8. The computer-implemented method of claim 3, wherein a global explanation of the explainable time series classifications is defined by:
$${w}_{c , k}^{m , δ} > 0$$
means occurrence of shapelet s is indicative of sample being in class c;
$${w}_{c , k}^{m , δ} = 0$$
means
$${s}_{k}^{m , δ}$$
is unrelated to class c;
$${w}_{c , k}^{m , δ} < 0$$
means occurrence shapelet s is indicative of sample not being in class c,
wherein c is a class, w is a weight in a corresponding linear regression,
$${s}_{k}^{m , δ}$$
represents a shapelet where m is a dimension, k is identifies the shapelet, and δ is an index for a length of a corresponding shapelet.

9. The computer-implemented method of claim 3, wherein the gating function is a modified Gini Index that measures a diversity of variables in an output \hat{R}ᵢ of the shapelet concept bottleneck model and is defined as:
$$g ( {X}_{i} ) = \frac{C \cdot {\sum }_{c = 1}^{C} {( {\hat{r}}_{i , c} )}^{2} - 1}{C - 1}$$
wherein c is a class, C is a count of classes, and \hat{r}_{i,c} are components.

10. The computer-implemented method of claim 3, wherein an output of the hybrid shapelet concept bottleneck model is a mixture of outputs of the shapelet concept bottleneck model, denoted as SBM, and the deep neural network, denoted as DNN, with ratio g(Xᵢ):
$$H ( {X}_{i} ) = SBM ( {X}_{i} ) \cdot g ( {X}_{i} ) + DNN ( {X}_{i} ) \cdot ( 1 - g ( {X}_{i} ) )$$
wherein H(Xᵢ) is an output of the hybrid shapelet concept bottleneck model.

11. The computer-implemented method of claim 10, wherein an overall loss function of the hybrid shapelet concept bottleneck model is:
$${ℒ}_{Hybrid} = {ℒ}_{SBM} + {\overline{ℒ}}_{ce}$$
where [symbol] _{ce} is a SoftMax cross-entropy loss on H(Xᵢ) to optimize an overall performance of the hybrid shapelet concept bottleneck model and [symbol] _{SBM} is an overall loss function of the shapelet concept bottleneck model.

12. The computer-implemented method of claim 3, further comprising:
determining that the explainable time series classifications provide a satisfactory explanation; and
performing an action based on the classification in response to determining that the explainable time series classifications provide the satisfactory explanation.

13. The computer-implemented method of claim 3, wherein the action is determining a treatment for a patient based on the explainable time series classifications.

14. The computer-implemented method of claim 3, wherein the action is managing a physical system and wherein the multivariate time series sample data is obtained from sensors configured to monitor the physical system.

15. The computer-implemented method of claim 3, further comprising:
determining that the explainable time series classifications fail to provide a satisfactory explanation; and
using at least one of a human subject expert or a deep neural network in response to determining that the explainable time series classifications fail to provide the satisfactory explanation.

16. A computer program product, comprising:
one or more tangible computer-readable storage media and program instructions stored on at least one of the one or more tangible computer-readable storage media, the program instructions executable by a processor, the program instructions comprising:
receiving multivariate time series sample data;
using a shapelet concept bottleneck model (SCBM) to determine a likelihood that a shapelet occurs by calculating an m^{th} dimension of a time series data point of the multivariate time series sample data and an m^{th} dimension of univariate shapelet, where the shapelet concept bottleneck model is a linear layer over the likelihood of the shapelet occurring;
training the shapelet concept bottleneck model with an additional classification loss with shapelet concept bottleneck model regularizations; and
generating the explainable time series classifications based on the trained shapelet concept bottleneck model.

17. A system comprising:
a memory; and
at least one processor, coupled to said memory, and operative to perform operations comprising:
receiving multivariate time series sample data;
using a shapelet concept bottleneck model (SCBM) to determine a likelihood that a shapelet occurs by calculating an m^{th} dimension of a time series data point of the multivariate time series sample data and an m^{th} dimension of univariate shapelet, where the shapelet concept bottleneck model is a linear layer over the likelihood of the shapelet occurring;
training the shapelet concept bottleneck model with an additional classification loss with shapelet concept bottleneck model regularizations; and
generating the explainable time series classifications based on the trained shapelet concept bottleneck model.

18. The system of claim 17, wherein the generating of the explainable time series classifications based on the trained shapelet concept bottleneck model includes generating local explainable time series classifications and global explainable time series classifications based on the trained shapelet concept bottleneck model.

19. The system of claim 17, the operations further comprising:
using a deep neural network (DNN) based on the multivariate time series sample data;
using Gumbel-SoftMax to generate an end-to-end differentiable model; and
based on the shapelet concept bottleneck model and the end-to-end differentiable model, generating a hybrid shapelet concept bottleneck model (H-SCBM) using a gating function to combine the shapelet concept bottleneck model with the deep neural network (DNN);
wherein:
the trained shapelet concept bottleneck model in the generating of the explainable time series classifications operation comprises a trained hybrid shapelet concept bottleneck model; and
the training of the shapelet concept bottleneck model with the additional classification loss with the shapelet concept bottleneck model regularizations comprises a training of a hybrid shapelet concept bottleneck model with an additional classification loss for the deep neural network with shapelet concept bottleneck model regularizations.

20. The system of claim 19, wherein the generating of the explainable time series classifications based on the trained hybrid shapelet concept bottleneck model includes generating local explainable time series classifications and global explainable time series classifications based on the trained hybrid shapelet concept bottleneck model.
